(19) United States
(12) Patent Application Publication
(10) Pub. No.: US 2025/0261020 A1
(43) Pub. Date: Aug. 14, 2025

(54) Inter-Cell L1-RSRP Measurements

(71) Applicant: Apple Inc., CUPERTINO, CA (US)

(72) Inventors: Manasa RAGHAVAN, Sunnyvale, CA (US); Jie CUI, San Jose, CA (US); Yang TANG, San Jose, CA (US); Qiming LI, Beijing (CN); Xiang CHEN, Palo Alto, CA (US); Dawei ZHANG, Saratoga, CA (US); Huaning NIU, San Jose, CA (US)

(21) Appl. No.: 18/857,933

(22) PCT Filed: Apr. 25, 2022
(86) PCT No.: PCT/CN2022/089061

§ 371 Date: Oct. 18, 2024

(51) Int. Cl. H04W 24/10; H04L 27/26

(52) U.S. Cl. CPC H04W 24/10; H04L 27/261

(57) ABSTRACT

A user equipment (UE) is configured to determine a first system synchronization block (SSB) having a subcarrier spacing (SCS) transmitted by a first cell having a first Physical Cell Identity (PCI) and a second SSB having the SCS transmitted by a second cell having a second PCI different from the first PCI are adjacent and perform inter-cell Layer 1 reference signal received power (L1-RSRP) measurements on the first and second SSBs based on a proximity rule.

### TECHNICAL FIELD

The present disclosure generally relates to communication, and in particular, to the inter-cell L1-RSRP measurements.

### BACKGROUND INFORMATION

In Rel-17 of the 5G New Radio (NR) standards FeMIMO (Further Enhanced MIMO), inter-cell Layer 1 reference signal received power (L1-RSRP) measurements by a user equipment (UE) are introduced. L1-RSRP measurements may be determined from reference signal (RS) measurements including a system synchronization block (SSB) (PBCH-DMRS) (SS-RSRP) or a channel state information (CSI) reference signal (CSI-RS) (CSI-RSRP). However, when performing inter-cell measurements, the L1-RSRP measurements may be performed on cells with different Physical Cell Identities (PCI) from the current serving cell. The RS from these different cells may overlap or be adjacent to each other. The UE should be configured to handle these inter-cell situations.

### SUMMARY

Some exemplary embodiments are related to a processor of a user equipment (UE) configured to perform operations. The operations include determining a first system synchronization block (SSB) having a subcarrier spacing (SCS) transmitted by a first cell having a first Physical Cell Identity (PCI) and a second SSB having the SCS transmitted by a second cell having a second PCI different from the first PCI are adjacent and performing inter-cell Layer 1 reference signal received power (L1-RSRP) measurements on the first and second SSBs based on a proximity rule.

Other exemplary embodiments are related to a user equipment (UE) having a transceiver configured to communicate with a base station and a processor communicatively coupled to the transceiver and configured to perform operations. The operations include determining a first system synchronization block (SSB) having a subcarrier spacing (SCS) transmitted by a first cell having a first Physical Cell Identity (PCI) and a second SSB having the SCS transmitted by a second cell having a second PCI different from the first PCI are adjacent and performing inter-cell Layer 1 reference signal received power (L1-RSRP) measurements on the first and second SSBs based on a proximity rule.

### BRIEF DESCRIPTION OF THE DRAWINGS

FIG. 1 shows an exemplary network arrangement according to various exemplary embodiments.

FIG. 2 shows an exemplary user equipment (UE) according to various exemplary embodiments.

FIG. 3 shows an exemplary base station according to various exemplary embodiments.

FIG. 4 shows a timing diagram for adjacent SSBs transmitted from different cells according to various exemplary embodiments.

FIG. 5 shows an exemplary sharing factor table for FR2 inter-cell L1-RSRP measurements for SSBs transmitted by a serving cell and a cell with a different PCI according to various exemplary embodiments.

FIG. 6 shows an exemplary information element (IE) for UE capability reporting for SSB measurements for different receiver (Rx) beams according to various exemplary embodiments.

FIG. 7 shows an exemplary signaling diagram for configuring the UE for L1-RSRP measurements according to various exemplary embodiments.

### DETAILED DESCRIPTION

The exemplary embodiments may be further understood with reference to the following description and the related appended drawings, wherein like elements are provided with the same reference numerals. The exemplary embodiments relate to a user equipment (UE) performing inter-cell Layer 1 reference signal received power (L1-RSRP) measurements when adjacent system synchronization blocks (SSBs) are transmitted by different cells having different Physical Cell Identities (PCI).

The exemplary embodiments are described with regard to a UE. However, reference to a UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any appropriate electronic component.

The exemplary embodiments are also described with regard to a 5G New Radio (NR) network. However, reference to a 5G NR network is merely provided for illustrative purposes. The exemplary embodiments may be utilized with any network that utilizes inter-cell L1-RSRP measurements. Therefore, the 5G NR network as described herein may represent any type of network that inter-cell L1-RSRP measurements.

The exemplary embodiments relate to scenarios where different cells having different PCIs transmit SSBs that are adjacent to each other. A UE may perform inter-cell L1-RSRP measurements on these SSBs. However, the UE may not be able to perform the measurements on adjacent SSBs because of hardware and/or software constraints.

The exemplary embodiments provide solutions to allow the UE to perform the measurements on the adjacent SSBs. In some exemplary embodiments, the UE is preconfigured with one or more proximity rules that define how the UE is to perform the L1-RSRP measurements when there are adjacent SSBs. In other exemplary embodiments, the UE is provided with the one or more proximity rules via an L1-RSRP measurement configuration that is received from the network. In either case, the proximity rules may comprise that the UE is to use a sharing factor that extends measurement time allowing the UE to perform the L1-RSRP measurements on the adjacent SSBs. The exemplary embodiments also provide signaling solutions to allow the UE to signal the network with respect to capabilities related to measuring adjacent SSBs.

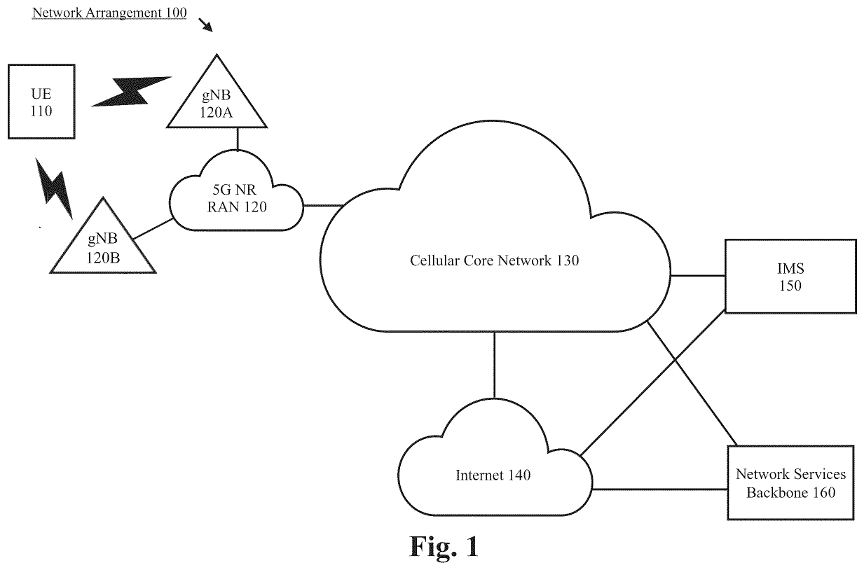

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, the UE 110 may also communicate with other types of networks (e.g., 5G cloud RAN, a next generation RAN (NG-RAN), a long term evolution (LTE) RAN, a legacy cellular network, a wireless local area network (WLAN), etc.) and the UE 110 may also communicate with networks over a wired connection. With regard to the exemplary embodiments, the UE 110 may establish a connection with the 5G NR RAN 120. Therefore, the UE 110 may have a 5G NR chipset to communicate with the NR RAN 120.

The 5G NR RAN 120 may be a portion of a cellular network that may be deployed by a network carrier (e.g., Verizon, AT&T, T-Mobile, etc.). The 5G NR RAN 120 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

Those skilled in the art will understand that any association procedure may be performed for the UE 110 to connect to the 5G NR RAN 120. For example, as discussed above, the 5G NR RAN 120 may be associated with a particular cellular provider where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific base station, e.g., the gNB 120A.

In the exemplary network arrangement 100, two base stations, the gNB 120A and gNB 120B, are shown. In this example it may be considered that gNB 120A is the serving cell and gNB 120B is a neighbor cell that has a different PCI than the serving cell. However, those skilled in the art will understand that this arrangement is only exemplary and there may be many other types of arrangements where the UE 110 will make L1-RSRP measurements on cells with different PCIs. For example, the gNB 120A or gNB 120B may each include multiple cells that may have different PCIs. The gNB 120A or gNB 120B may have remotely located transmission and reception points (TRPs) that have different PCIs. There may be multiple neighbor cells for gNB 120A in addition to the gNB 120B. It should be understood that the exemplary embodiments may apply to any of these scenarios or any other scenario where the UE 110 is performing L1-RSRP measurements on cells with different PCIs.

The network arrangement 100 also includes a cellular core network 130, the Internet 140, an IP Multimedia Subsystem (IMS) 150, and a network services backbone 160. The cellular core network 130 may refer an interconnected set of components that manages the operation and traffic of the cellular network. It may include the evolved packet core (EPC) and/or the 5G core (5GC). The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

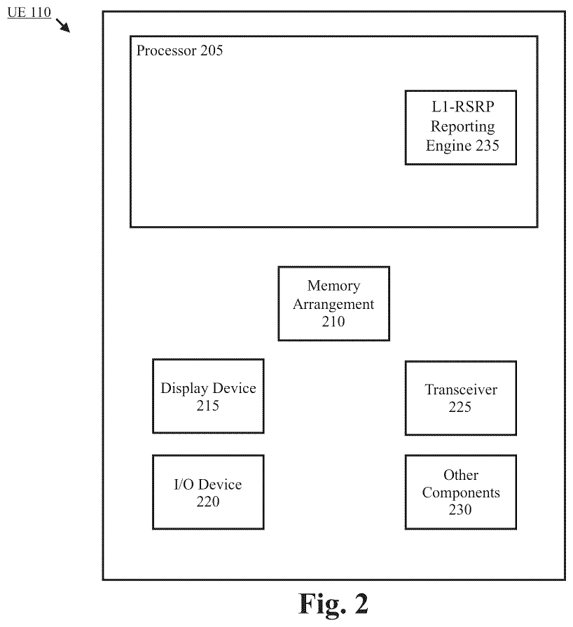

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute a plurality of engines of the UE 110. For example, the engines may include a L1-RSRP reporting engine 235. The L1-RSRP reporting engine 235 may perform various operations, including but not limited to, reporting the capabilities of the UE 110 with respect to measuring adjacent SSBs from cells having different PCIs and performing L1-RSRP measurements on adjacent SSBs. Each of these operations will be described in greater detail below.

The above referenced engine 235 being an application (e.g., a program) executed by the processor 205 is merely provided for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G NR-RAN 120, an LTE-RAN (not pictured), a legacy RAN (not pictured), a WLAN (not pictured), etc. Accordingly, the transceiver 225 may operate on a variety of different frequencies or channels (e.g., set of consecutive frequencies).

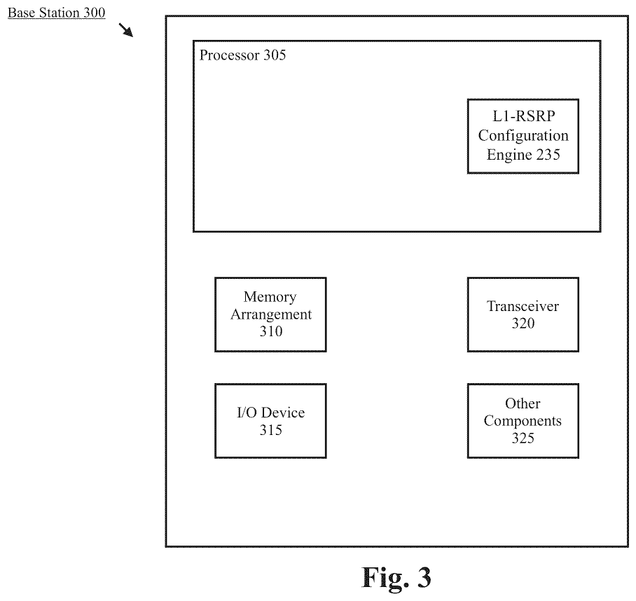

FIG. 3 shows an exemplary base station 300 according to various exemplary embodiments. The base station 300 may represent the gNB 120A, gNB 120B or any other access node through which the UE 110 may establish a connection and manage network operations.

The base station 300 may include a processor 305, a memory arrangement 310, an input/output (I/O) device 315, a transceiver 320 and other components 325. The other components 325 may include, for example, an audio input device, an audio output device, a battery, a data acquisition device, ports to electrically connect the base station 300 to other electronic devices and/or power sources, etc.

The processor 305 may be configured to execute a plurality of engines for the base station 300. For example, the engines may include a L1-RSRP configuration engine 330. The L1-RSRP configuration engine 330 may perform various operations including but not limited to, configuring the UE 110 with an L1-RSRP measurement configuration based on capabilities related to measuring adjacent SSBs from cells having different PCIs reported by of the UE 110. Each of these operations will be described in greater detail below.

The above noted engine 330 being an application (e.g., a program) executed by the processor 305 is only exemplary. The functionality associated with the engine 330 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.). The exemplary embodiments may be implemented in any of these or other configurations of a base station.

The memory 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UE in the network arrangement 100. The transceiver 320 may operate on a variety of different frequencies or channels (e.g., set of consecutive frequencies). Therefore, the transceiver 320 may include one or more components (e.g., radios) to enable the data exchange with the various networks and UEs.

As described above, the UE 110 may perform inter-cell L1-RSRP measurements. In some cases, the RS (e.g., SSBs) for the L1-RSRP measurements that are transmitted by cells having different PCIs may overlap or be adjacent to each other. This may cause a problem for the UE 110 to measure the overlapping/adjacent SSBs.

In the current 3GPP standards, there are various conditions to be satisfied for performing inter-cell L1-RSRP measurements. These conditions include SSBs from the serving cell and the cell with the different PCI have the same center frequency, sub-carrier spacing (SCS) and system frame number (SEN) offset. In addition, during the predetermined time (e.g., 5 seconds) before L1-RSRP measurement is configured, the UE 110 has sent a valid Layer 3 (L3) measurement report for the cell with the different PCI. Furthermore, the timing offset between the serving cell and the cell with the different PCI are within the cyclic prefix (CP). In describing the exemplary embodiments, it will be considered that these conditions are satisfied and L1-RSRP measurements may be performed. However, it should be understood that the exemplary embodiments are not limited to scenarios where these specific conditions are used.

When SSBs of cells with a different PCI overlaps with SSBs from a serving cell (e.g., same SSB index) or when SSBs of cells with a different PCI are adjacent to SSBs from a serving cell (examples of SSB indices that are adjacent will be described in greater detail below), the UE 110 may include sharing factors for Frequency Range 2 (FR2) measurements. A sharing factor may be considered to be a factor that is used to configure the UE 110 to perform the L1-RSRP measurements for a particular time period for the serving cell or the neighbor cell. Typically, the sharing factor extends the measurement occasion for the SSB for which it is applied.

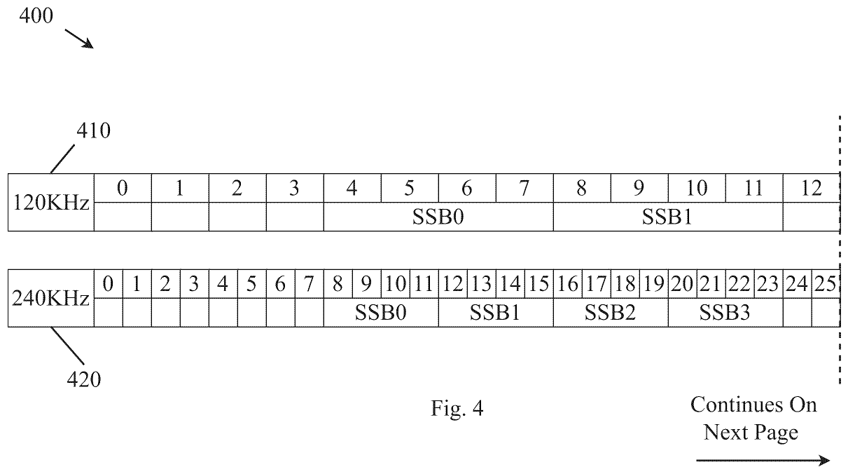

FIG. 4 shows a timing diagram 400 for adjacent SSBs transmitted from different cells according to various exemplary embodiments. As described above, in the exemplary embodiments, it may be considered that gNB 120A is the serving cell and gNB 120B is the cell with the different PCI from the serving cell. The UE 110 may perform L1-RSRP measurements in FR2 for the gNB 120A and the gNB 120B.

In FR2, the SSBs for the gNB 120A and the gNB 120B may be adjacent to each other. For example, referring to FIG. 4, there are two different SSB configurations, a first SSB configuration 410 for a SCS of 120 kHz and a second SSB configuration 420 for a SCS of 240 KHz. In the first configuration 410, it may be considered that the SSB0 is transmitted by the serving gNB 120A and the adjacent SSB1 is transmitted by the gNB 120B having a different PCI. Similarly, the SSB2 is transmitted by the serving gNB 120A and the adjacent SSB3 is transmitted by the gNB 120B having a different PCI. For a SCS of 120 kHz, SSBs are adjacent for an SSB index 2k and 2k+1 (k=0, 1, 2, . . . 31) as shown by example in FIG. 4. Thus, in the example of an SCS of 120 kHz, SSBs are considered to be adjacent based on there being no intervening symbols between a last symbol of a first SSB and a first symbol of a second SSB as shown in FIG. 4.

In the second configuration 420, it may be considered that the SSB0 is transmitted by the serving gNB 120A, the adjacent SSB1 is transmitted by the gNB 120B having a different PCI, the next adjacent SSB2 is transmitted by the serving gNB 120A and the next adjacent SSB3 is transmitted by the gNB 120B having a different PCI. Similarly, the SSB4 is transmitted by the serving gNB 120A, the adjacent SSB5 is transmitted by the gNB 120B having a different PCI, the next adjacent SSB6 is transmitted by the serving gNB 120A and the next adjacent SSB7 is transmitted by the gNB 120B having a different PCI. For a SCS of 240 kHz, SSBs are adjacent between SSB index 4*l+k and 4*l+k+1, where l=0, 1, . . . 15 and k=0, 1, 2 as shown by example in FIG. 4. Thus, in the example of an SCS of 240 kHz, SSBs are considered adjacent when the SSBs transmitted by the different cells are in a continuous block of symbols without any intervening symbols between the multiple SSBs in the block.

It should be understood that the specific arrangement of adjacent SSBs as described above is only exemplary. The exemplary embodiments are not limited to the arrangement as described above. For example, in the first configuration 410, the gNB 120B having a different PCI may transmit the first SSB0 and the serving gNB 120A may transmit the adjacent SSB1. In another example for the second configuration 420, the serving gNB 120A may transmit the SSB0 and SSB1 and the gNB 120B having a different PCI may transmit the SSB2 and SSB3, e.g., the adjacent SSBs in the set for the different cells are SSB1 and SSB2.

Because the adjacent SSBs are transmitted by cells with different PCIs, the UE 110 may have to switch receiver (Rx) beams between these SSBs, i.e., the Rx beam for adjacent SSBs may not be same since they are for L1 measurements from different cells. Switching Rx beams may be a hardware operation and/or a software/firmware operation for the UE 110 that takes a certain period of time. The time associated with the Rx beam switching operation may cause the UE 110 to miss some or all of the next adjacent SSB.

Thus, the UE 110 should not miss adjacent SSBs from cells with different PCIs. As described above, one manner of the UE 110 avoiding missing SSBs is to provide the UE 110 with a sharing factor for the L1-RSRP measurements in FR2 for cells with different PCIs.

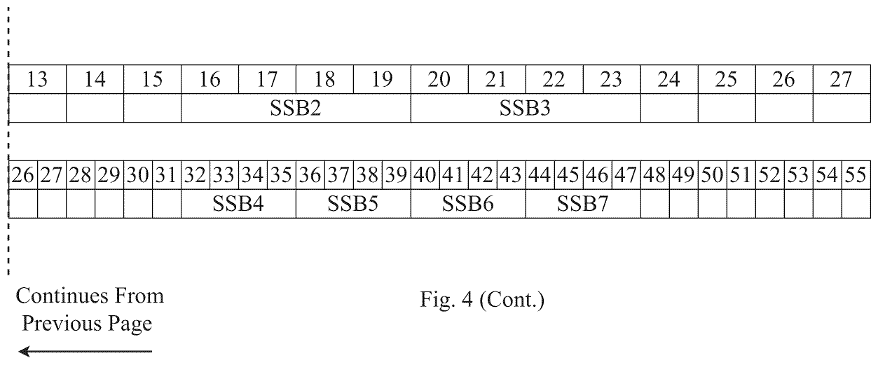

FIG. 5 shows an exemplary sharing factor table for FR2 inter-cell L1-RSRP measurements for SSBs transmitted by a serving cell and a cell with a different PCI according to various exemplary embodiments. In FIG. 5, P_{SC} refers to the sharing factor for the serving cell, P_{CDP} refers to the sharing factor for the cell with the different PCI, T_{SSB,SC} refers to the timing (duration) of the SSB for the serving cell, T_{SSB,NSC} refers to the timing (duration) of the SSB for the cell with the different PCI and T_{SMTC} refers to the timing (duration) of SS/PBCH Block Measurement Timing Configuration (SMTC). As can be seen from the table 500, the sharing factor for each cell depends on the various timing considerations for the SSBs and SMTC. It should be understood that the values for the sharing factor in table 500 are only exemplary and that other sharing factor values may be used. That is, the exemplary embodiments are not limited to any particular sharing factor values but are related to various scenarios when sharing factors should be used for adjacent SSBs from cells with different PCIs.

The following provides various proximity rules for overlapping and/or adjacent SSBs from cells with different PCIs for L1-RSRP measurements by the UE 110. In some exemplary embodiments, the proximity rules may comprise, if the SSB from the serving cell and a cell with a different PCI are adjacent, then the UE 110 should apply a sharing factor for the L1-RSRP measurements. In other exemplary embodiments, if the SSBs from two cells with different PCIs (e.g., two different neighbor cells which are not serving cells) are overlapping or adjacent, then the UE 110 should apply a sharing factor for the L1-RSRP measurements for these two cells.

In further exemplary embodiments, when the SCS is 240 KHz and the SSBs from cells with different PCIs are in a group of 4 SSBs that are adjacent (e.g., as described above for the second configuration 420 with reference to FIG. 4), then the UE 110 should apply a sharing factor for the SSBs from cells having different PCIs. In this exemplary embodiment, the SSB index may be considered to be in the group {4*lm, 4*l+1, 4*l+2, 4*l+3}, where l=0, 1, . . . 15.

The implementation of the sharing factors may depend on the capabilities of the UE 110. This implementation may affect the value of the sharing factors applied by the UE 110. For example, when performing a transmission configuration indication (TCI) state switching to a cell with a different PCI, in the case of an unknown TCI, the delay includes L1-RSRP measurement time. As described above, the sharing factor extends the measurement time. The UE 110 capability may be used to determine the sharing factor, the measurement time and/or the switching delay. Thus, the network, when receiving the capabilities of the UE 110, may configure the UE 110 with the correct sharing factors based on the UE 110 capability. As described above with reference to FIG. 5, these sharing factors may be defined in a table of the 3GPP standards. In another example, the sharing factors may be individually calculated based on the UE 110 capability reporting.

In addition, the UE 110 capability reporting may also affect whether the UE 110 applies the sharing factor. For example, as was described above, the adjacent SSBs from cells with different PCIs may cause a problem for L1-RSRP measurements by the UE 110 because of the Rx switching time. Since Rx switching time is a UE implementation issue, some UEs may have the capability to perform the Rx switching without having to use the sharing factor. Thus, the UE 110 may report its capabilities to the network and based on this capability reporting, the network may configure the UE 110 with specific sharing factor rules and with specific values for the sharing factor.

In one example for the 120 kHz SCS configuration, the UE 110 may indicate if it can switch Rx beams for adjacent SSBs in 120 KHz (in each block of 2). If the UE 110 indicated it can switch the Rx beams, this means the UE 110 would not have to apply the sharing factor and the network does not need to configure the UE 110 with a sharing factor for adjacent SSBs.

In another example for the 120 kHz SCS configuration, the UE 110 may indicate how many SSBs it can measure in the group of 2 SSBs with 120 KHz SCS. For example, if the UE 110 indicates 1 (e.g., the UE 110 can measure 1 SSB in the group of 2 SSBs), the sharing factor may be applied if there are SSBs from cells with different PCIs in the group. If the UE 110 indicates 2 (e.g., the UE 110 can measure 2 SSBs in the group of 2 SSBs), no sharing factor will apply if the SSBs are non-overlapping.

In an example for the 240 kHz SCS configuration, the UE 110 may indicate how many SSBs it can measure in the group of 4 SSBs with 240 kHz SCS. For example, if the UE 110 indicates 1, the sharing factor may be applied if SSBs from cells with different PCIs are in the group. If the UE 110 indicates 2, the sharing factor may be applied when the adjacent SSBs from cells with different PCIs are k, k+1 in the group of 4 SSBs. If the UE indicates 4, no sharing factor will apply if SSBs are non-overlapping.

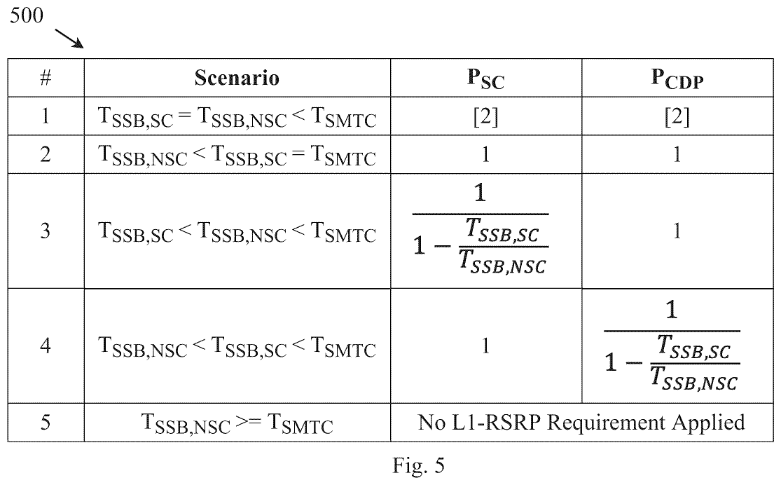

FIG. 6 shows an exemplary information element (IE) 600 for UE capability reporting for SSB measurements for different Rx beams according to various exemplary embodiments. In this example, the IE 600 is named numSSBMeasureDiffBeam. However, it should be understood that this name is only exemplary. As shown in FIG. 6, this IE 600 may be used by the UE 110 to report the number of SSBs the UE can measure with different Rx beams within a block of adjacent SSBs. The candidate values for the SCS of 120 kHz or 240 kHz were described in the examples above, e.g., 1 or 2 for an SCS of 120 kHz, 1, 2 or 4 for an SCS of 240 kHz.

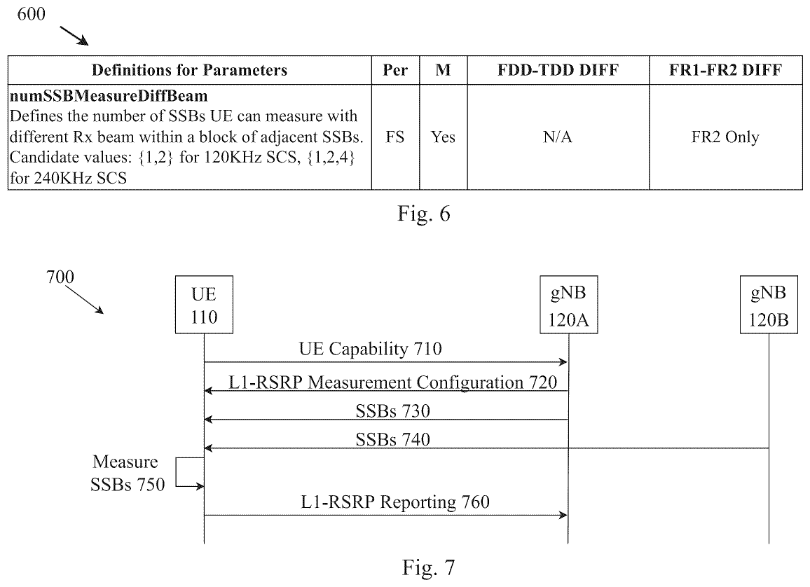

FIG. 7 shows an exemplary signaling diagram 700 for the UE 110 reporting L1-RSRP measurement capabilities to the network according to various exemplary embodiments. To continue with the example started above, it will be considered that the gNB 120A is the serving cell and the gNB 120B is the cell having the different PCI.

In 710, the UE 110 may report the UE capability information to the service cell gNB 120A. As described above, the UE capability information may be reported using the numSSBMeasureDiffBeam IE 600 or any other manner of reporting the UE capability information. The numSSBMeasureDiffBeam IE 600 may be reported in Radio Resource Control (RRC) signaling, Medium Access Control (MAC) signaling or any other manner of signaling between the UE 110 and the gNB 120A. As also described above, the UE capability information may include the capabilities of the UE 110 with respect to measuring adjacent SSBs that are transmitted by different cells having different PCIs. In this example, the different cells having different PCIs may be considered to be the gNB 120A and gNB 120B.

In 720, the serving cell gNB 120A sends the L1-RSRP measurement configuration to the UE 110. As described above, the L1-RSRP measurement configuration may include proximity rules related to whether and under what conditions a sharing factor may be used for the adjacent SSB measurements for the different cells having different PCIs, an indication that the UE should use the sharing factor, values for the sharing factor, etc.

Once the UE 110 is configured for the L1-RSRP measurements, the gNB 120A transmits SSBs in 730 and the gNB 120B transmits SSBs in 740. In 750, the UE 110 will measure the SSBs according to the L1-RSRP measurement configuration. In 760, the UE 110 will report the L1-RSRP measurements to the serving cell gNB 120A.

It should be understood that in the example of FIG. 7, the UE 110 is reporting L1-RSRP measurement capabilities to the network and the network is then configuring the UE 110 to perform the L1-RSRP measurements. However, this is only exemplary and there is no requirement that the network configure the UE 110 to perform the L1-RSRP measurements. As described for some of the above exemplary embodiments, the UE 110 may be preconfigured with the proximity rules for performing the L1-RSRP measurements such that the UE 110 does not require the network to configure UE 110 to perform the L1-RSRP measurements. That is, the operation 720 described above does not need to be performed as the UE 110 may have the preconfigured proximity rules.

### EXAMPLES

In a first example, a method performed by a user equipment (UE), comprising determining a first system synchronization block (SSB) having a subcarrier spacing (SCS) transmitted by a first cell having a first Physical Cell Identity (PCI) and a second SSB having the SCS transmitted by a second cell having a second PCI different from the first PCI are adjacent and performing inter-cell Layer 1 reference signal received power (L1-RSRP) measurements on the first and second SSBs based on a proximity rule.

In a second example, the method of the first example, wherein the SCS is 120 kHz and the first and second SSBs are adjacent based on there being no intervening symbols between a last symbol of the first SSB and a first symbol of the second SSB.

In a third example, the method of the second example, wherein the proximity rule is based on at least a UE capability related to measuring the first and second SSBs, wherein the UE capability comprises one of (i) the UE is capable of measuring only one of the SSBs without applying a sharing factor or (ii) the UE is capable of measuring both of the SSBs without applying a sharing factor.

In a fourth example, the method of the third example, wherein, when the UE is capable of measuring only one of the SSBs without applying a sharing factor, the proximity rule comprises the UE using the sharing factor for the L1-RSRP measurements of the first and second SSBs.

In a fifth example, the method of the second example, wherein the first cell is a serving cell and the second cell is a neighbor cell or the first cell is a first neighbor cell and the second cell is a second neighbor cell.

In a sixth example, the method of the first example, wherein the SCS is 240 kHz and the first and second SSB are adjacent based on the first and second SSB being in a continuous block of symbols with a third and fourth SSB without any intervening symbols between the SSBs in the block.

In a seventh example, the method of the sixth example, wherein the proximity rule is based on at least a UE capability related to measuring the first and second SSBs, wherein the UE capability comprises one of (i) the UE is capable of measuring only one of the SSBs in the block without applying a sharing factor, (ii) the UE is capable of measuring two of the SSBs in the block without applying a sharing factor or (iii) the UE is capable of measuring all four SSBs in the block without applying a sharing factor.

In an eighth example, the method of the sixth example, wherein, when the UE capability is indicates the UE is only capable of measuring less than all of the four SSBs in the block, the proximity rule comprises the UE using a sharing factor for the L1-RSRP measurements of the first and second SSBs.

In a ninth example, the method of the eighth example, wherein the sharing factor is a first sharing factor when the UE is capable of measuring only one of the SSBs in the block without applying a sharing factor and a different second sharing factor when the UE is capable of measuring two of the SSBs in the block without applying a sharing factor.

In a tenth example, the method of the first example, wherein the SCS is 120 kHz and the first and second SSBs are adjacent based on there being no intervening symbols between a last symbol of the first SSB and a first symbol of the second SSB, further comprising sending, to a network, UE capability information comprising a capability related to L1-RSRP measurements of adjacent SSBs, wherein the UE capability information indicates whether the UE can switch receiver (Rx) beams to measure the first and second SSBs.

In an eleventh example, the method of the first example, wherein the first and second SSBs are in a block, further comprising sending, to a network, UE capability information comprising a capability related to L1-RSRP measurements of adjacent SSBs, wherein the UE capability information indicates a first value indicating the UE can measure one of the SSBs in the block or a second value indicating the UE can measure both of the SSBs in the block.

In a twelfth example, the method of the first example, wherein the SCS is 240 kHz and the first and second SSB are adjacent based on the first and second SSB being in a continuous block of symbols with a third and fourth SSB without any intervening symbols between the SSBs in the block, and wherein the third SSB is transmitted by the first cell and the fourth SSB is transmitted by the second cell, further comprising sending, to a network, UE capability information comprising a capability related to L1-RSRP measurements of adjacent SSBs, wherein the UE capability information indicates a first value indicating the UE can measure one of the SSBs in the block, a second value indicating the UE can measure two of the SSBs in the block or a third value indicating the UE can measure all four SSBs in the block.

In a thirteenth example, a method is performed by a base station, comprising receiving, from a user equipment (UE), UE capability information comprising a capability related to inter-cell Layer 1 reference signal received power (L1-RSRP) measurements for system synchronization blocks (SSBs) having a subcarrier spacing (SCS) transmitted by a first cell having a first Physical Cell Identity (PCI) and SSBs having the SCS transmitted by a second cell having a second PCI different from the first PCI, wherein a first SSB transmitted by the first cell is adjacent to a second SSB transmitted by the second cell, configuring a L1-RSRP measurement configuration for the UE based on the UE capability information and sending, to the UE, the L1-RSRP measurement configuration.

In a fourteenth example, the method of the thirteenth example, wherein the base station is the first cell and the first cell is a serving cell for the UE.

In a fifteenth example, the method of the thirteenth example, wherein the SCS is 120 kHz and the first and second SSBs are adjacent based on there being no intervening symbols between a last symbol of the first SSB and a first symbol of the second SSB.

In a sixteenth example, the method of the fifteenth example, wherein the UE capability information indicates whether the UE can switch receiver (Rx) beams to measure the first and second SSBs.

In a seventeenth example, the method of the sixteenth example, wherein, when the UE capability information indicates the UE cannot switch Rx beams to measure the first and second SSB, the L1-RSRP measurement configuration comprises an indication that a sharing factor is to be used to measure the first and second SSBs.

In an eighteenth example, the method of the fifteenth example, wherein the first and second SSBs are in a block, and wherein the UE capability information indicates a first value indicating the UE can measure one of the SSBs in the block or a second value indicating the UE can measure both of the SSBs in the block.

In a nineteenth example, the method of the eighteenth example, wherein, when the UE capability information indicates the first value, the L1-RSRP measurement configuration comprises an indication that a sharing factor is to be used measure the first and second SSBs.

In a twentieth example, the method of the eighteenth example, wherein, when the UE capability information indicates the second value, the L1-RSRP measurement configuration does not include an indication that a sharing factor is to be used to measure the first and second SSBs.

In a twenty first example, the method of the thirteenth example, wherein the SCS is 240 Hz and the first and second SSB are adjacent based on the first and second SSB being in a continuous block of symbols with a third and fourth SSB without any intervening symbols between the SSBs in the block.

In a twenty second example, the method of the twenty first example, wherein the third SSB is transmitted by the first cell and the fourth SSB is transmitted by the second cell, and wherein the UE capability information indicates a first value indicating the UE can measure one of the SSBs in the block, a second value indicating the UE can measure two of the SSBs in the block or a third value indicating the UE can measure all four SSBs in the block.

In a twenty third example, the method of the twenty second example, wherein, when the UE capability information indicates the first value, the L1-RSRP measurement configuration comprises an indication that a sharing factor is to be used to measure the ones of the SSBs from the first and second cells that are adjacent.

In a twenty fourth example, the method of the twenty second example, wherein, when the UE capability information indicates the second value, the L1-RSRP measurement configuration includes an indication that a sharing factor is to be used when one of the SSBs transmitted by the first cell is adjacent in time to one of the SSBs transmitted by the second cell.

In a twenty fifth example, the method of the twenty second example, wherein, when the UE capability information indicates the third value, the L1-RSRP measurement configuration does not include an indication that a sharing factor is to be used to measure the SSBS.

In a twenty sixth example, the method of the thirteenth example, wherein the UE capability information is received via an information element (IE).

In a twenty seventh, a processor of a base station configured to perform any of the operations of the thirteenth through twenty sixth examples.

In a twenty eighth, a base station comprising a transceiver configured to communicate with a user equipment (UE) and a processor communicatively coupled to the transceiver and configured to perform any of the operations of the thirteenth through twenty sixth examples.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as ios, Android, etc. In a further example, the exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. A processor of a user equipment (UE) configured to perform operations comprising:
determining a first system synchronization block (SSB) having a subcarrier spacing (SCS) transmitted by a first cell having a first Physical Cell Identity (PCI) and a second SSB having the SCS transmitted by a second cell having a second PCI different from the first PCI are adjacent; and
performing inter-cell Layer 1 reference signal received power (L1-RSRP) measurements on the first and second SSBs based on a proximity rule.

2. The processor of claim 1, wherein the SCS is 120 kHz and the first and second SSBs are adjacent based on there being no intervening symbols between a last symbol of the first SSB and a first symbol of the second SSB.

3. The processor of claim 2, wherein the proximity rule is based on at least a UE capability related to measuring the first and second SSBs, wherein the UE capability comprises one of (i) the UE is capable of measuring only one of the SSBs without applying a sharing factor or (ii) the UE is capable of measuring both of the SSBs without applying a sharing factor.

4. The processor of claim 3, wherein, when the UE is capable of measuring only one of the SSBs without applying a sharing factor, the proximity rule comprises the UE using the sharing factor for the L1-RSRP measurements of the first and second SSBs.

5. The processor of claim 2, wherein the first cell is a serving cell and the second cell is a neighbor cell or the first cell is a first neighbor cell and the second cell is a second neighbor cell.

6. The processor of claim 1, wherein the SCS is 240 kHz and the first and second SSB are adjacent based on the first and second SSB being in a continuous block of symbols with a third and fourth SSB without any intervening symbols between the SSBs in the block.

7. The processor of claim 6, wherein the proximity rule is based on at least a UE capability related to measuring the first and second SSBs, wherein the UE capability comprises one of (i) the UE is capable of measuring only one of the SSBs in the block without applying a sharing factor, (ii) the UE is capable of measuring two of the SSBs in the block without applying a sharing factor or (iii) the UE is capable of measuring all four SSBs in the block without applying a sharing factor.

8. The processor of claim 6, wherein, when the UE capability is indicates the UE is only capable of measuring less than all of the four SSBs in the block, the proximity rule comprises the UE using a sharing factor for the L1-RSRP measurements of the first and second SSBs.

9. The processor of claim 8, wherein the sharing factor is a first sharing factor when the UE is capable of measuring only one of the SSBs in the block without applying a sharing factor and a different second sharing factor when the UE is capable of measuring two of the SSBs in the block without applying a sharing factor.

10. The processor of claim 1, wherein the SCS is 120 kHz and the first and second SSBs are adjacent based on there being no intervening symbols between a last symbol of the first SSB and a first symbol of the second SSB, the operations further comprising:
sending, to a network, UE capability information comprising a capability related to L1-RSRP measurements of adjacent SSBs, wherein the UE capability information indicates whether the UE can switch receiver (Rx) beams to measure the first and second SSBs.

11. The processor of claim 1, wherein the first and second SSBs are in a block, the operations further comprising:
sending, to a network, UE capability information comprising a capability related to L1-RSRP measurements of adjacent SSBs, wherein the UE capability information indicates a first value indicating the UE can measure one of the SSBs in the block or a second value indicating the UE can measure both of the SSBs in the block.

12. The processor of claim 1, wherein the SCS is 240 kHz and the first and second SSB are adjacent based on the first and second SSB being in a continuous block of symbols with a third and fourth SSB without any intervening symbols between the SSBs in the block, and wherein the third SSB is transmitted by the first cell and the fourth SSB is transmitted by the second cell, the operations further comprising:
sending, to a network, UE capability information comprising a capability related to L1-RSRP measurements of adjacent SSBs, wherein the UE capability information indicates a first value indicating the UE can measure one of the SSBs in the block, a second value indicating the UE can measure two of the SSBs in the block or a third value indicating the UE can measure all four SSBs in the block.

13. A user equipment (UE), comprising:
a transceiver configured to communicate with a base station; and
a processor communicatively coupled to the transceiver and configured to perform operations comprising:
determining a first system synchronization block (SSB) having a subcarrier spacing (SCS) transmitted by a first cell having a first Physical Cell Identity (PCI) and a second SSB having the SCS transmitted by a second cell having a second PCI different from the first PCI are adjacent; and
performing inter-cell Layer 1 reference signal received power (L1-RSRP) measurements on the first and second SSBs based on a proximity rule.

14. The UE of claim 13, wherein the SCS is 120 kHz and the first and second SSBs are adjacent based on there being no intervening symbols between a last symbol of the first SSB and a first symbol of the second SSB.

15. The UE of claim 14, wherein the proximity rule is based on at least a UE capability related to measuring the first and second SSBs, wherein the UE capability comprises one of (i) the UE is capable of measuring only one of the SSBs without applying a sharing factor or (ii) the UE is capable of measuring both of the SSBs without applying a sharing factor.

16. The UE of claim 15, wherein, when the UE is capable of measuring only one of the SSBs without applying a sharing factor, the proximity rule comprises the UE using the sharing factor for the L1-RSRP measurements of the first and second SSBs.

17. The UE of claim 13, wherein the first cell is a serving cell and the second cell is a neighbor cell or the first cell is a first neighbor cell and the second cell is a second neighbor cell.

18. The UE of claim 13, wherein the SCS is 240 kHz and the first and second SSB are adjacent based on the first and second SSB being in a continuous block of symbols with a third and fourth SSB without any intervening symbols between the SSBs in the block.

19. The UE of claim 18, wherein the proximity rule is based on at least a UE capability related to measuring the first and second SSBs, wherein the UE capability comprises one of (i) the UE is capable of measuring only one of the SSBs in the block without applying a sharing factor, (ii) the UE is capable of measuring two of the SSBs in the block without applying a sharing factor or (iii) the UE is capable of measuring all four SSBs in the block without applying a sharing factor.

20. The UE of claim 19, wherein, when the UE capability is indicates the UE is only capable of measuring less than all of the four SSBs in the block, the proximity rule comprises the UE using a sharing factor for the L1-RSRP measurements of the first and second SSBs.
